(19) United States
(12) Patent Application Publication
(10) Pub. No.: US 2013/0275851 A1
(43) Pub. Date: Oct. 17, 2013

(54) System and Method for Web Directory and Search Result Display and Web Page Identifications

(71) Applicant: Qin Zhang, Los Angeles, CA (US)

(72) Inventor: Qin Zhang, Los Angeles, CA (US)

(21) Appl. No.: 13/447,151

(22) Filed: Apr. 13, 2012

(51) Int. Cl. G06F 17/00

(52) U.S. Cl. 715/234

(57) ABSTRACT

The present invention relates to a system and method for information process of web pages using artificially constructed apparatus. More specially, in one preferred embodiment of the present invention, web pages are processed to obtain types of web pages according to information related to the web pages or contents of the web pages, wherein the information related the web pages includes url addresses (links) of the web pages, icons (or texts) for links for the web pages, metadata of the web pages, etc.

### CROSS REFERENCE TO RELATED APPLICATIONS

The present application claims the benefit of and incorporates in full the non-provisional application entitled “Thinking System and Method” with application Ser. No. 13/068,376 filed on May 9, 2011, the non-provisional application entitled “Search Method and System Using Thinking System” with application Ser. No. 13/065,132 filed on Mar. 14, 2011, the non-provisional application entitled “A System and Method for Information Processing and Motor Control” with application Ser. No. 12/452,249 filed on Dec. 18, 2009, the non-provisional application entitled “Content Summarizing and Search Method and System” with application Ser. No. 12/586,414 filed on Sep. 21, 2009, the non-provisional application entitled “Search Methods and Various Applications” with application Ser. No. 12/590,394 filed on Nov. 6, 2009. The present application claims the benefit of and incorporate in full, and as continuation-in-part of the non-provisional application entitled “System and Method for Web Directory and Search Result Display” with application Ser. No. 12/384,597 filed on Apr. 7, 2009, and “System and Method for Web Page Identifications” with application Ser. No. 12/800,712 filed on May 19, 2010.

### FIELD OF INVENTION

The present invention relates to a system and method for providing information process of web contents. More specially, the present invention provides a system and method of identifying types of web pages or web sites according to information related to the web pages or web sites and contents of the web pages or web sites.

### BACKGROUND OF THE INVENTION

Information in the Internet is not organized. Search engine results are not sorted, and the results are arranged in a random-like lists. Although search engines spent huge resources trying to provide the results that the users are looking for, but many search terms related to many different search results, and different users often need to find many different results, so one list of search results often cannot best serve all users. This is especially truth if the search terms are common nouns, or other descriptive types of terms that do not represent specific entities, such as names for business entities.

Cluster search engines try to solve this problem by dividing the search results in different categories. Web directories also try to list web sites in different categories. But the problem is these arrangements do not provide categories in the way that will help users to navigate the web easily. The display for these search results and web directories are generally provided in “linear arrangement”, i.e., the clusters of entries are treated as if they are distinguished by features that are of same types and are exclusive, while in fact the clusters are often arranged according to features that are not of same types and not exclusive. In many cases, the clusters contained information that is not directly related to the subject, but information that are related to subject indirectly.

In addition, since the categories are divided in one dimension, the displays try focus more and more on one particular subject of content and particular type of websites or web pages, while many types of websites or web pages are still mixed together without divisions.

### SUMMARY OF THE INVENTION

The present invention provides ways of identifying the types of web pages or web sites that help to provide a new way of arrangements for web directories and the search results that is user friendly. Basically, the web directories and search results are arranged according to two types of criteria, content and usage. Lists of web sites or web pages including certain contents (such certain words or phrases) are divided according to types of web sites or web pages, while these lists of web sites or web pages including certain contents can be grouped according to the contents. Lists of web sites or web pages having key words or phrases can be displayed according to the types of usages of web sites or web pages, while key words or phrases can be grouped into different categories according to similar features. In this arrangement, the lists of web sites or web pages can be limited to the lists of web sites or web pages that have certain contents, and the types of web sites or web pages in the lists can be related to the types of contents, but the types of web sites or web pages in the lists are not narrowed for contents in same categories with narrower meanings.

In one preferred embodiment of the present invention, the web directories or search results are arranged in “multiple dimensions”, i.e., lists of information such as names and addresses for web sites or web pages including certain contents (such as certain words or phrases) are divided according to types of web sites or web pages and displayed in web pages or web displays, then the web pages or web displays for the lists are linked according to contents that lists for contents regarding subjects that are similar in meaning can be grouped together and linked to contents regarding subjects that are broader in meaning. This arrangement can be continued for several levels. In addition, the lists of information for web sites or web pages including contents regarding subjects that are related in other ways can also be linked together. As different lists are linked in many different ways, the displays of websites or web pages are clearly divided and reflect the multi-dimensional links between various subjects.

In one preferred embodiment of the present invention, a thinking system comprises: an information gathering system, an information inquiry system, an information output system, a knowledge structure, a process structure, a document structure, an executing system, and a system log.

The knowledge structure comprises numerous element files and a file organizing mechanism. Each element file contains information identifying and distinguishing the element and knowledge indicating direct connections of this element with other elements. The identifying information is about whether the element is a word, a phrase, a symbol, or a graphic, etc., and for a word, what language is the word, and whether the word is a noun, a verb, a pronoun, etc., what types of noun, verb, pronoun, etc., and further classification. The link information is about whether the meaning of the word is general, specific, or interchangeable with other words, the way the element is supposed to be used in sentences, the conditions and results related with the element, the attributes of the element, and other information indicating how this element is related to other elements.

The document structure of the present invention comprises document entry files, document addresses, document contents, and a document organizing mechanism. In one preferred embodiment of the present invention, the document entry files include key words or phrases and other words or phrases describing features of the key words and phrases with the corresponding words or phrases identifying the types of features.

In one preferred embodiment of the present invention, a document entry file in the document structure for each web page are established. The document entry files include information related to the types of web pages, and information related to the contents of the web pages. When displaying web directories, or displaying search results, web pages can be arranged according to types or purposes of the web pages, in addition to occurrence of the contents.

In one preferred embodiment of the present invention, web pages are processed to obtain types of web pages according to information related to the web pages or contents of the web pages, wherein the information related the web pages includes url addresses (links) of the web pages, icons (or texts) for links for the web pages, metadata of the web pages, etc.

### BRIEF DESCRIPTION OF THE DRAWINGS

The above and further features and advantages of the present invention may be appreciated from the detailed description of preferred embodiments with reference to the accompanying drawings, in which:

FIG. 1a is an exemplary illustration of the organizational index of the web directories of one preferred embodiment of the present invention;

FIG. 1b is an exemplary illustration of a display page of the web directories or web search results of one preferred embodiment of the present invention;

FIG. 2a is a schematic illustration of one preferred embodiment of the implication of the system of the present invention;

FIG. 2b is a schematic illustration of one preferred embodiment of the computer hardware implication of the system of the present invention;

FIG. 2c is a network schematic of an embodiment of the system of the present invention for the application of web directory or Internet search;

FIG. 3 is a schematic illustration of one preferred embodiment of the knowledge structure of the system of the present invention;

FIG. 4 is an exemplary illustration of a word tree in a first link information file of an element file in the knowledge structure of the system of the present invention;

FIG. 5 is a schematic illustration of one preferred embodiment of the executing system of the system of the present invention;

FIG. 6 is a schematic illustration of one preferred embodiment of the process of executing system of the system of the present invention,

### DESCRIPTION OF THE PREFERRED EMBODIMENTS

The detailed description set forth below in connection with the appended drawings is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

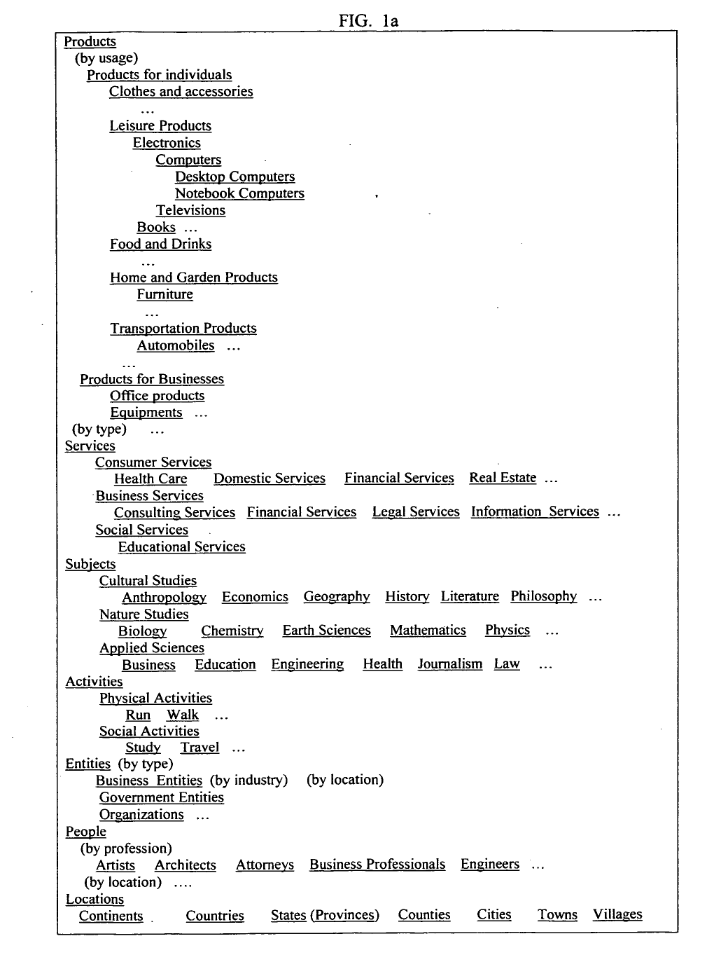

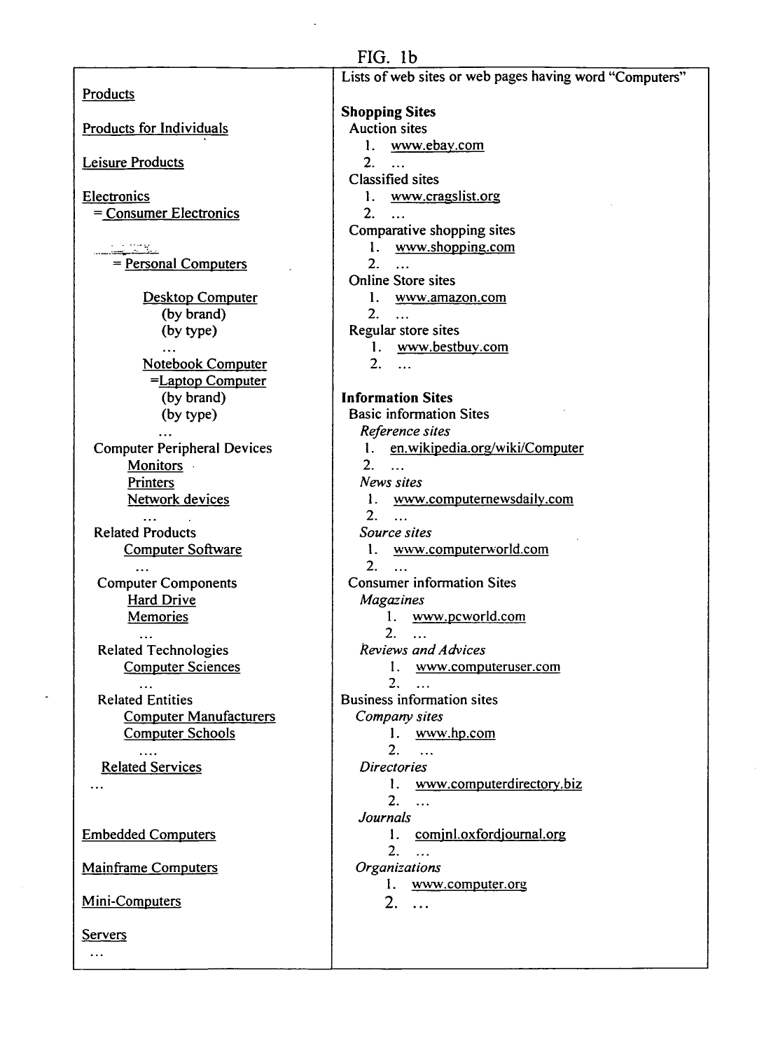

The present invention provides a new way of arrangements for web directories and the search results that is user friendly. In one preferred embodiment of the present invention, as in FIG. 1a (a partial index of a web directory is provided for illustration purpose), web directories are arranged according to various types of words or phrases regarding various subjects, including words or phrases for products, services, abstract subjects, activities, entities, people, locations, etc., wherein words or phrases are grouped under the categories of products, services, subjects, activities, entities, people, locations, etc., and under sub-categories, wherein words or phrases under certain categories or sub-categories have certain similar and particular features, and words or phrases under the same sub-categories have more similar features with each other than words or phrases under higher level categories. Words or phrases can be alternative sub-categories under different criteria. For example, products can be grouped by usage, how they are made, etc., and people can be grouped by profession, location, etc.

Each word or phrase in the web directory has a main web page. The layout for display web page for each word or phrase can be different for different types of words or phrases. For example, as in FIG. 1b (a partial display of a main page for word “computer” as in a web directory or search results is provided for illustration purpose), when the word or phrase is a name for a product, a list of websites (or web pages) with information for the product will be divided into different groups such as websites that are selling the products and websites that provide information related to the product. These groups can be further divided into subgroups. For example, when the word or phrase is a name for a product, the websites or web pages that are selling the products can be further divided into groups of auction sites, comparative shopping sites, online shopping sites, and web sites for conventional stores, business to business sites, etc., wherein the ranking of the sites can be determined by how many items are for sales on each site, or dense of traffic, etc., and websites that provide information related to the product can divided into groups of web sites providing basic information, consumer information, business information, etc., wherein the ranking of the sites can be determined by how the contents in the websites or web pages are related to the subjects, wherein websites providing basic information include websites or web pages for references such as online dictionaries and encyclopedias, news sites, source sites and other basic informational web sites, wherein websites providing consumer information include websites or web pages for product review sites, magazine websites, weblogs, etc., wherein websites providing business information include websites or web pages for manufacturers and other companies, business directories, business associations, business journals, industry newsletters, and database, etc.

Different words or phrases can be used to identify same product or service, web pages for information related to these words or phrases can be established in the same way, and the main page for the product or service may provide links to web pages or web displays for different names for the same product or service.

In addition, web pages for information regarding other products and services that are related to the product or service can be established, and the main page for the product or service may provide links to web pages for other products and services that are related to the product or service. For example, links to web pages for information for components of the product, or accessories of the product, or services for the product can also be provided in the main page for the word or phrase for the product. For example, for “computer”, other products such as printer, scanner, monitor, network devices, etc. can be grouped together as peripheral devices. Other groups of products related to computer could be computer software, etc.

In one preferred embodiment of the present invention, as in FIG. 1b, links to the web pages of lists of web sites or web pages including other words or phrases indirectly related to the product can be provided in the main web page for the product. For example, displays of lists of web sites or web pages including other words or phrases as names for companies that made the product, names for the technologies, methods, processes and machines or tools etc. used for making the product can also be provided and linked to the main page for the word or phrase for the product, so that web pages for information related to the products or services can also provide links to web pages for information related to other types of subjects such as company names, technology, etc. The advantage of this display is that information regarding many web sites or web pages that do not include words or phrases such as “computers”, but include words or phrases related to such words or phrases as “computers” will be provided.

Words or phrases represent subjects of similar types generally can be grouped together that can be identified by words or phrases that are used to identify these groups. These words or phrases can be further grouped and be identified by words or phrases that are used to identify the broader groups. For example, as seen in FIG. 1a and FIG. 1b, in one preferred embodiment of the present invention, web pages of web directories for words or phrases identifying products and services can be organized into different groups and sub-groups that have specific features. For example, web pages for “desktop computers” and “laptop computers” can be grouped together under the category for “computers”, which can be further grouped with others such as “televisions” under “electronics”, which can be further grouped with others such as “books” under “leisure products”, which can be further grouped with others such as “transportation products” under “products for individuals”, which can be further grouped with others such as “products for businesses” under “products”.

Words or phrases represent objects or subjects with many features. To organize words or phrases narrower in meanings, many different ways of dividing the groups can be used. To avoid confusions, within the same levels, only one type of feature can be used as criteria to divide the group, but different type of feature can be used as criteria to divide the group in different levels. For example, in FIG. 1a, “products” are first divided by usage in first and second levels, but within the “leisure products” group, the sub-groups are “electronics” and “books”, etc., so that in this level the criteria is by type (make or composition) not by usage. In FIG. 1b, in “desktop computers” group or “laptop computers” group, further divisions can be based on “brand”, “type”, etc., not limited by “usage” either. The difficulty is that common used categorization are based on different criteria. For example, “computers” often is treated as a separate group along with “electronics” because the importance in usage, and other groups such as “toys” are grouped by function, not by make or composition.

Internet search results can also be displayed in similar way. In one preferred embodiment of the present invention, a document structure can be provided that document entry files include words or phrases as document entry file names, and lists of web pages or web sites having the words or phrases, along with the web addresses for the web pages or web sites, and information for the types of web sites or web pages will be included in the document entry files. In one embodiment of the present invention, the lists of web pages or web sites are prearranged according to types of web pages or web sites. When Internet users input search terms, and the search terms are words or phrases that are names of the document entry files, the system of the present invention only need to find the document entry files, and display the information in the document entry files. In another embodiment of the present invention, the lists of web pages or web sites are not prearranged according to types of web pages or web sites. When Internet users input search terms, and the search terms are words or phrases that are names of the document entry files, the system of the present invention not only need to find the document entry files, it will also need to read the lists of the web pages or web sites in the document entry files and arrange the display lists according to predetermined rules based on types of web pages or web sites, and inputted terms. If no exact matches found with inputted terms and words or phrases as names of the document entry files, but partial matches can be found, then these partial matches can be displayed.

In one preferred embodiment of the present invention, a document structure can be provided that document entry files include names for web sites or web pages as document entry file names, and key words or phrases of the web sites or web pages grouped with words or phrases describing features of the key words or phrases, as well as words or phrases identifying the corresponding features, and the web addresses for the web pages or web sites will also be included in the document entry files. Information for the types of web sites or web pages is also included in the document entry files. For this embodiment, when Internet users input search terms, and the search terms are words or phrases that are included in the contents of document entry files, then information in the document entry files regarding web pages or web sites having the search terms will be used to provide lists of web pages or web sites having search terms, and the lists of web pages or web sites can be arranged according to the types of web sites or web pages.

In one preferred embodiment of the present invention, the input information are analyzed, wherein information related to the input terms will be obtained. In one preferred embodiment of the present invention, words or phrases that have similar meanings as the inputted terms are obtained and used to search web sites or web pages accordingly. The search results for words or phrases having similar meanings as the inputted terms can be displayed in separated web pages according to same process as web pages or web displays for the inputted terms, wherein the web pages for the search results of the inputted terms can provide links to the web pages or web displays for words or phrases having similar meanings as the inputted terms. Similarly, words or phrases that have broader or narrower meanings as the inputted terms can be found and used to search web sites or web pages accordingly. The search results can be displayed in web pages for each of the words or phrases that have broader or narrower meanings as the inputted terms, wherein the web pages or web displays for the search results of the inputted terms can provide links to the web pages or web displays for words or phrases that have broader or narrower meanings as the inputted terms. In addition, words or phrases that indicate features of the inputted terms can also be obtained and used to search web sites or web pages. The search results can be displayed in web pages or web displays for each of the words or phrases that indicate features of the inputted terms, wherein the web pages or web displays for the search results of the inputted terms can provide links to the web pages for words or phrases that indicate features of the inputted terms. The links to web pages for words or phrases that indicate features of the inputted terms can be arranged according to types of features they describe, and they can be further grouped for displays.

If more than one terms are inputted by the users, it is still assumed that the users are trying to find one thing for each input. The inputted terms could be terms that identifying things (subject words or phrases) and terms that describing things (feature words or phrases). The inputted terms can also include words or phrases that identify the types of features (attributes) that feature words or phrases are used to describe for the searches. For example, if the inputted terms are pairs of words or phrases describing certain features of the products or services and words or phrases identifying corresponding features, then information of web pages or web sites including the pairs of words or phrases matching the pairs of inputted words or phrases can be obtained and names and other features of the products or services can also be obtained through searches. Then the list of web pages or web sites including products or services that have the features described by the inputted words or phrases can be displayed. The list can be arranged by the types of features of the products or services, by the names of the products or services, and by the types of web pages or web sites. Further searches by the names of the products or services can be conducted, and provide the links to the results.

The search method for Internet searching web pages and web sites can also be used for document searches in other document structures.

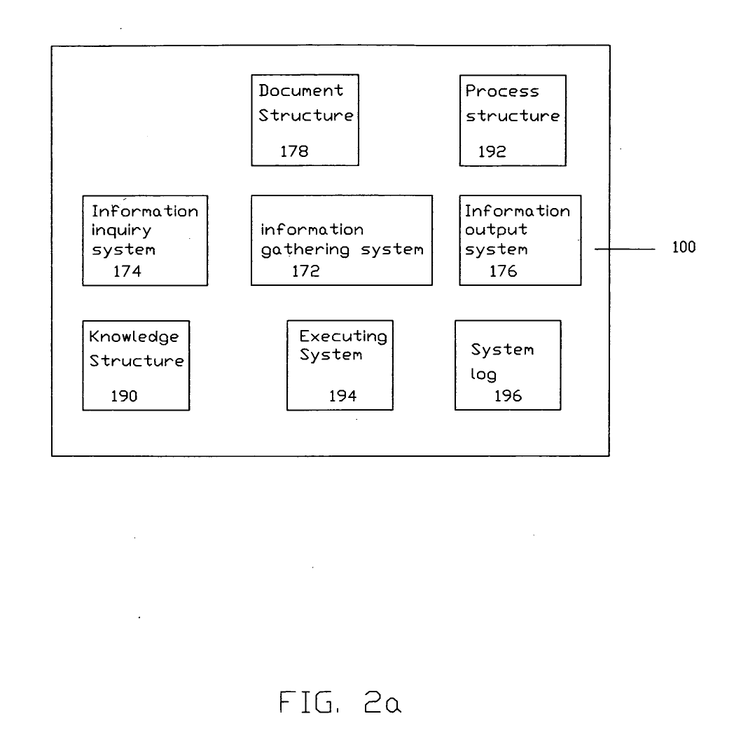

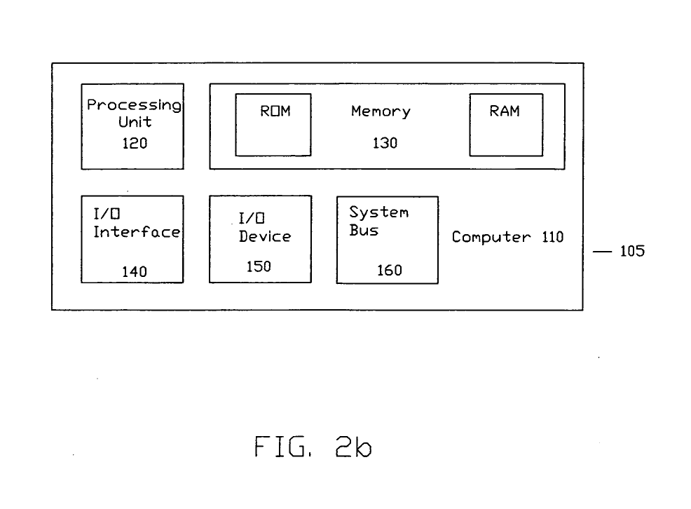

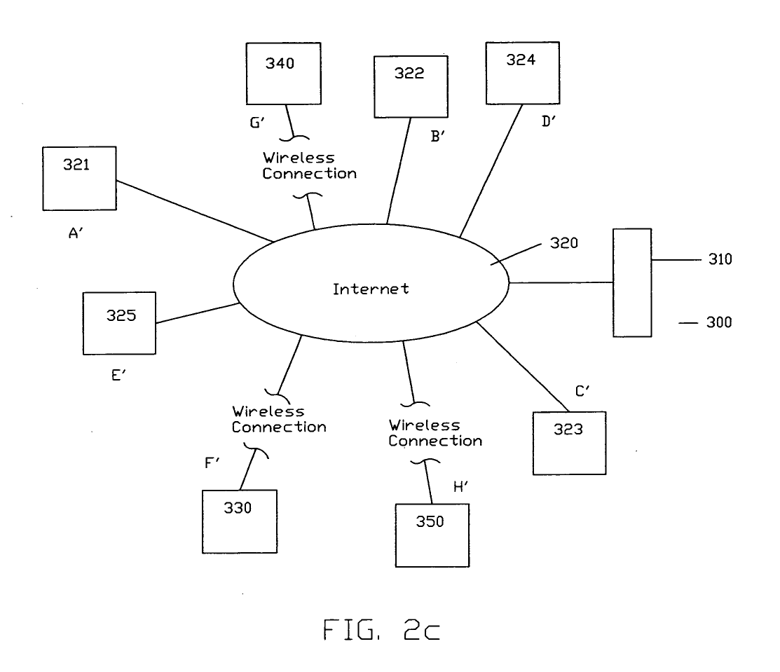

In one preferred embodiment of the present invention, as shown in FIG. 2a, a thinking system 100 comprises: an information gathering system 172, an information inquiry system 174, an information output system 176, a knowledge structure 190, a process structure 192, a document structure 178, an executing system 194, and a system log 196.

In one preferred embodiment of the present invention, as shown in FIG. 2b, a computer hardware system 105 is used as part of the embodiment of the present invention that includes at least one computer 110, having at least a processing unit 120, a memory 130, an I/O interface 140, an I/O device 150, and a system bus 160 that interconnects various system components to the processing unit. The memory includes at least one read only memory (ROM) and one random access memory (RAM). A basic I/O interface, containing the basic routines that help to transfer information between elements within the computer, such as during start-up, is stored in ROM. The system bus comprises bus structures such as address buses, data buses, and control buses.

In this embodiment, the information gathering system 172 includes I/O devices 150 that provide input to the computer 110, and the information inquiry system 174, the information output system 176 are I/O devices 150 that the computer 110 provides control. The knowledge structure 190, the process structure 192, the document structure 178, the executing system 194, and the system log 196 are mostly software systems that are contained in the memory 130. The operation of the executing system 194 is mostly realized through the operation of at least one processing unit 120.

The information gathering system 172 may further comprises a word input system, and a touch/scan input system. The document structure 178 could be located in a remote location in a computer network, or can be dispersed in various locations connected by one or more networks.

In a preferred embodiment, the knowledge structure 190, the process structure 192, the document structure 178, the executing system 194, and the system log 196, can be duplicated.

In one preferred embodiment of the present invention, as shown in FIG. 2c, a schematic of an embodiment of system 300 for the application of web directory or Internet search is presented. The system 300 includes web directory server or search engine server 310 that is connected to the Internet 320 through an Internet service provider (ISP). Web users A′, B′, C′, D′, E′, F′, G′, H′, are connected to Internet 320 through devices such as personal computers 321, 322, and 323, a work station 324, a network terminal 325, or wireless communication devices such wireless telephone 330, a PDA 340, or other wireless device 350, or other devices that are able to provide two-way communications. In this embodiment, the web directory server or search engine server 310 may include a knowledge structure, a document structure, and an executing system. The web directory server or search engine server may include more than one servers located in different locations.

### Knowledge Structure

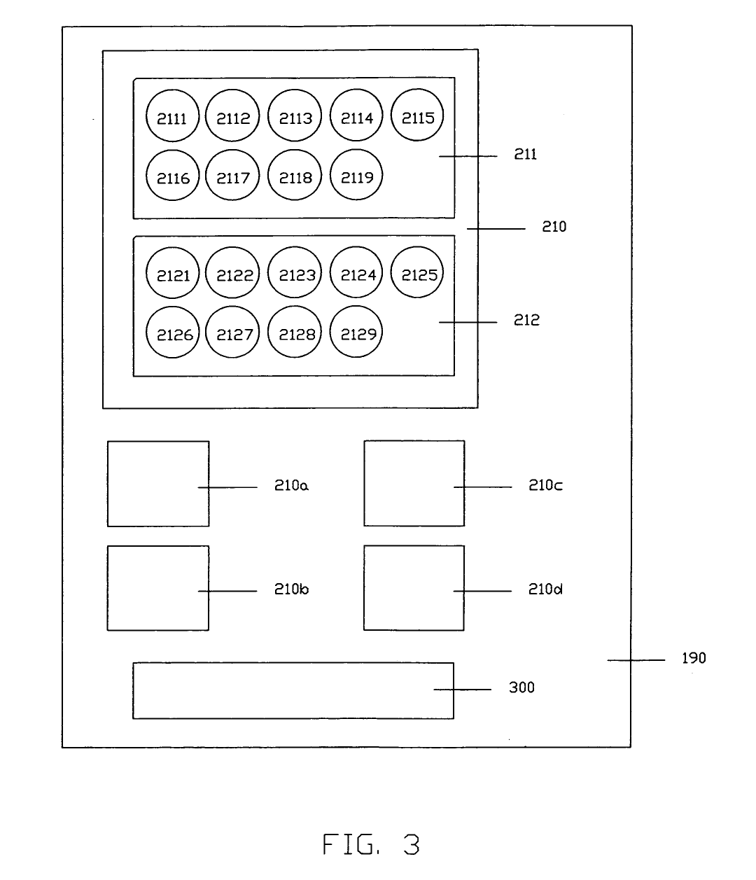

In one preferred embodiment of the present invention, as shown in FIG. 3, the knowledge structure 190 of the present invention comprises knowledge files and file organizing mechanism 300. In one preferred embodiment of the present invention, the knowledge structure 190 can be realized by database application, such as relation database application.

The knowledge files comprises numerous element files 210. Each element file 210 comprises an identification file 211, and a link file 212.

In a preferred embodiment, the identification file 211 comprises a first identification value 2111, a second identification value 2112, a third identification value 2113, a fourth identification value 2114, a fifth identification value 2115, a sixth identification value 2116, a seventh identification value 2117, a eighth identification value 2118, and a ninth identification value 2119. Different identification values of an element file can trigger different actions of the executing system 194.

In one preferred embodiment, the first identification value 2111 indicates the first element file 210 is a file for a word. The second identification value 2112 indicates what type of language is the word. In general the first identification value 2111 of a element file 210 could indicates whether the element is a word, a phrase, a sentence, a paragraph, a collection of paragraphs, even a book, a process, a symbol, a graphic, a formula, a sound or some other type of record.

The third identification value 2113 indicates whether the word is a noun, a verb, a pronoun, a verbal, an adjective, an adverb, an article, a preposition, a conjunction, or an interjection. In general, the second identification value 2112 through the ninth identification value 1119 could be any feature indication or a blank value.

The fourth identification value 2114 indicates the classes of nouns, verbs, pronouns, adjectives, and adverbs. The nouns are divided into classes including common nouns, proper nouns, collective nouns, count nouns, mass nouns, concrete nouns, abstract nouns. The verbs are divided into classes including transitive, intransitive, linking verbs, and auxiliary verbs. Pronouns fall into several classes including personal pronouns, indefinite pronouns, demonstrative pronouns, the relative pronouns, intensive and reflexive pronouns, intensive pronouns, reflexive pronouns, interrogative pronouns. Adjectives are divided into descriptive adjectives, limiting adjectives, possessives, words that show number, demonstrative adjectives, interrogative adjectives, and numbers, proper adjectives, attributive adjectives, predicate adjectives. Adverbs can be divided into classes of modifiers of verbs, adjectives and other adverbs; sentence modifiers. Words of different classes represent different meanings, usage, and corresponding sentence structures.

The fifth identification value 2115 indicates the forms of nouns, verbs, pronouns, adjectives, and adverbs. Nouns have forms in subjective and objective case, possessive case, and plural. Verbs have forms of simple, past tense, past participle, present participle, and -s form. Pronouns have forms of subjective, objective, possessive. Adjectives have three forms: positive, comparative, and superlative. Adverbs have three forms: positive, comparative, and superlative. Words in different forms reflect their functions, usage, and corresponding sentence structures.

In one preferred embodiment, the sixth identification value 2116 indicates the category of a noun (or noun phrase), whether it is for who, what, where, when or how.

In one preferred embodiment, the seventh identification value 2117 indicates the category of a word (or word phrase) to correspond to document structure categorization. For example, the seventh identification value 2117 can indicate whether the word (or phrase) is used to indicate whether it is used to describe business type, product or services, etc.

In one preferred embodiment, the eighth identification value 2118 identifies the key words for document summarization.

The link file 212 indicates the connections the element has with other elements. The link file 212 comprises a first link information file 2121, a second link information file 2122, a third link information file 2123, a fourth link information file 2124, a fifth link information file 2125, a sixth link information file 2126, a seventh link information file 2127, an eighth link information file 2128, and a ninth link information file 2129.

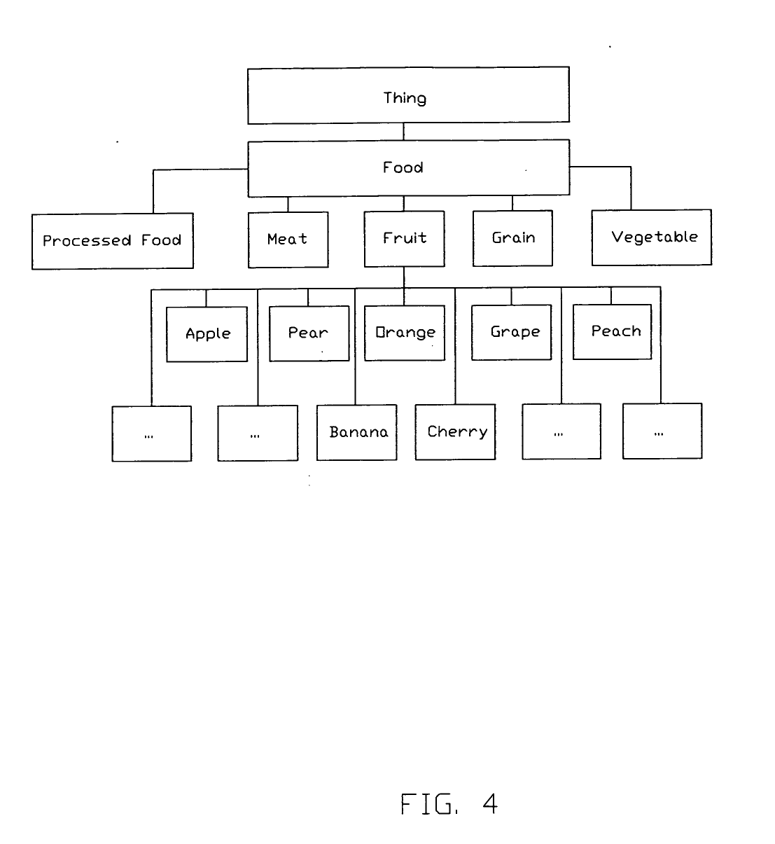

In a preferred embodiment, the first link information file 2121 establishes vertical connections between words. The first link information file 2121 comprises a word tree field, and an information field. The word tree field contains one or more groups of words connected by a tree like structure, wherein the word in the top of the tree structure is most general in meaning Going down the tree structure, the words will be more specific in meaning. Preferably, the word tree structure should contain all words that have vertical connection with this element. For example, for the element file for fruit, the word tree field may contain thing, food, fruit, apple, pear, orange, etc. as indicated in FIG. 4. In general, a word in lower level should be able to replace the word in the upper level in just about all sentences. If in some situations there are exceptions (usually when words in the word tree fields have multiple meanings, and only one meaning related to the word of the element file), these exceptions should be provided in the information field. If the word of the element file has more than one meaning, more than one word tree can be provided in the word tree field, and the condition or usage of the different word trees will be indicated in the information field. Phrases can be treated like words as for elements of the element files, or in the element files, with indication that they are phrases functioning as words.

The first link information file 2121 would likely be blank for pronouns, propositions, conjunctions, interjections, and articles.

The second link information file 2122 establishes horizontal connections between words. The second link information file 2122 comprises word field, and word information field. The word field contains words that are interchangeable with the word of the element file 210. If in some situations there are exceptions (for example, when the word has different meanings), these exceptions should be provided in the word information field. The words that have similar meaning with the word of the element file 212 can also be included in the word field, wherein the word information field will contain the differences in meanings and functions of the words. The word field may also contain the words in different forms with the same meaning as the word of the element file 210, wherein the word information field will indicate difference in usages and functions. The word field may also contain words in other languages that have similar meanings as the word of the element file 210, wherein the word information field will indicate the usage and corresponding sentence structures information, etc. Phrases can be treated like words as for elements of the element files, or in the element files, with indication that they are phrases functioning as words. The second link information files are especially useful for nouns, verbs, pronouns in related to different forms, or tenses, or moods, or voices and their usages.

Pronouns are used as the replacement of nouns. The second link information file 2122 for a pronoun will indicate the noun or nouns that the pronoun is equivalent in meaning and usage to (often of nouns that are most general in meaning of the group). Difference forms can also be indicated with the information in different usages and functions.

The second link information file 2122 would likely be blank for propositions, conjunctions, interjections, and articles.

The third link information file 2123 establishes the way the word will be used in a sentence. The information in the third link information file 2123 usually contains information for the specific ways the word is used in sentences. The third link information file 2123 comprises a link field, and a link information field. For nouns, pronouns, the link field may contain their effects on verbs to change forms, the specific words they can be associated with, and specific changes in the sentence structure. For a noun, this file may indicate the link between the phrases that contain this noun with other words. For a verb, the link field may contain sentences that reflect the sentence structures of which the verb can be used. By using the words (nouns, pronouns, other verbs, etc.) that are most general in meaning to construct the sentences, the links between this verb and other words can be established. The link information filed indicates the condition for the verb can be used in these sentences.

The third link information file 2123 can also establish links for words in different groups but have related meaning. For example, verb “act” is related to noun “action”. This link can be indicated in the third link information file 2123 for both words.

For propositions, conjunctions, interjections, and articles, the third link information file 2123 may indicate the functions of the word of the element file in the sentences. A proposition always connects a noun, a pronoun, or a word group functioning as a noun to another word in the sentence. The noun, pronoun, or word group so connected is the object of the preposition. The preposition plus its object and any modifiers is a prepositional phrase. The third link information file 2123 of a proposition may contain commonly used prepositional phrase wherein other words in the phrases are in most possible general terms in meanings.

The fourth link information file 2124 establishes the conditions or occurrences that will cause the action or condition represented by the word. This file can be blank for the word of the element file that is a noun, pronoun. For verbs, this file can provide information as to why the action takes place. The link between the cause and the word of the element file can be absolute, i.e., if the conditions or occurrences are true, then the action that is represented by the word of the element file will occur. This is often represented by “if and then” phrase, and other words in the sentence should be the most general type of the words.

For adjectives, the fourth link information file 2124 may provide information why the condition exists. The link between the cause and the condition can also be absolute, conditional, or a possibility. The fourth link information file 2124 may also provide information why the condition exists for adverbs.

The fifth link information file 2125 establishes what will be the result of the action represented by the word. This file is for verbs mostly. The link between the word and the result can be absolute, conditional, or a possibility. The sentences could also be in the format of “if-then”. As for the fourth link information file, there should be numerous links in the fifth link information file for the most time. It is the goal of the link files, as well as of the fourth link information files and the fifth link information files, to establish all possible links between words or phrases through direct links and indirect links. The links can also be established by using existing process files.

The sixth link information file 2126 contains identifying attributes and informational attributes of the word. The attributes are words that describe the characteristics of the word of the element file. Generally speaking, the sixth link information file 2126 is for nouns, and maybe verbs. The contents are words that define the fields and defined fields with or without values. For word that is general in meaning, most of the defined fields will not have values. For word that is the most specific, all the fields may have values. Words less general in meaning share the attributes for words that are more general in meaning linked by the word tree, but words general in meaning usually do not share all the attributes of the words less general in meaning linked by the word tree. Alternatively, the attribute information can be expressed in plain language. The identifying attributes usually are attributes with values that are unique to the element. The informational attributes can be in any thing related to the element. The format for the attributes can be as sentences or tables or forms, formulas, etc.

It can be noticed that if an attribute (especially an identifying attribute) of a word that does not have a value is assigned with a value, it will be equivalent to a word that is less general in meaning and linked by the word tree. For example, “person” is more general than “teacher” and linked with “teacher” by the word tree. So, a person who teaches will be a teacher.

People or places may have the same names but have different attributes. For example, John Smith is a frequently used name for many males, but they will have different birthdays, different heights and weights, and different occupations, and different personal characteristics. Paris in France is totally different from Paris in Texas of United States. The differences in the attributes may be reflected in separate and distinguish files in the sixth link information files, but it may be better that different element files are established for each person or place. These element files can be arranged in sub-element files under the same general names, and distinguished by distinct attributes, and specific identification number or value can be assigned to each element file.

Adjectives and adverbs usually indicate where, when, how, or to what extent, these features can be defined attributes of the nouns or verbs. Many adjectives can provide values or information of the attributes of the nouns.

The seventh link information file 2127 establishes connections between word that indicates attributes of other words with those other words. This link information file indicates links that is the reverse side of the sixth link information file 2126. If a word is usually used as attribute or description of other words, then this file identify the word that this word defined or being attributed for. To reduce the size of the file, if the word is an attribute for a group of words linked by word tree, the seventh link information file 2127 may include only the word most general in meaning For example, the word color can describe a physical existence, i.e., a thing. Therefore, seventh link information file 2127 may indicate that color is an attribute of a thing.

The comparative form or superlative form of adjectives and adverbs establish links for objects with similar values of the attributes.

The eighth link information file 2128 indicates the derivative attributes or derivative values of the word of the element file. For example, for word “place”, geographic location will be attribute for the place, and derivative attributes will be distance of this place with other places.

The ninth link information file 2129 indicates the connections between word that indicates the derivative attributes of other words with those other words. This link information file indicates links that are the reverse sides of the information indicated by the eighth link information file 2128. If a word can be used as derivative attribute of other words, then this file identify those other words. To reduce the size of the file, if the word is a derivative attribute for a group of words linked by a word tree, the ninth link information file 2129 may include only the word most general in meaning in the word tree.

The fourth link information file 2124, the fifth link information file 2125, the sixth link information file 2126, the seventh link information file 2127, the eighth link information file 2128, and the ninth link information file 2129 would likely be blank for propositions, conjunctions, interjections, and articles.

Other link information could be indicated in these link information files or other link information files.

If the element is a phrase, the first identification value 2111 indicates it is a file for a phrase. The second identification value 2112 indicates what type of language is the phrase. The third identification value 2113 indicates whether the phrase has the function of a noun, a verb, an adjective, an adverb, a preposition, a conjunction, or an interjection.

If the element is a symbol, a graphic, a sound or some other type of record, the second identification value 2112 through the ninth identification value 2119 could be any feature indication or a blank value. The element files may contain the link between each other, the link between it and a word or phrase, and other information related.

The element files generally have words or word phrases as file names, thus processing conducted by executing system that involve searching the element files will be accomplished by searching the element files that have the words or word phrases as file names.

### Document Structure

A document structure comprises document entry files, document addresses, document contents, and a document organizing mechanism, wherein each document content corresponds to a document address, wherein the document entry files including information related to the corresponding document contents, and document addresses of the document contents, wherein the document organizing mechanism provides access to the document contents according to the document addresses. The document structure may further comprise document summary files, and document summary file addresses, wherein the document entry files provide the document summary file addresses of the document summary files. The document contents can be separated from the document structure wherein the document addresses can be used to locate the document contents. In one preferred embodiment of the present invention, the document entry files can be organized by database application, such as relation database application.

The document structure can be used for organizing documents within a closed computer system or documents in a broader environment (such as in the World Wide Web), wherein each web page or web sites can be treated as a document.

In one preferred embodiment of the present invention, the document entry files comprise document names (as document entry file names) and content words or phrases of the documents, and corresponding address information of the documents respectively. Other information such as types of documents or web pages or web sites (such as the usages or purposes of the documents or web pages, i.e., whether the web page is for a shopping site, an information site, such as a news site, a weblog site, a site for a company, etc.) and summaries of the documents can also be included.

For this embodiment, documents or web pages or web sites can be indexed by key words or phrases (terms for subjects), and other words or phrases linked to the key words or phrases and with word or phrases identifying the characteristics of the links. The words or phrases linked with the key words or phrases can be determined according to the word element files of the key words or phrases. For different kinds of key words or phrases, different types of words or phrases will be linked with them. For example, the key words or phrases could be the names of the products or services, and words or phrases describing features of the products or services and words or phrases identifying the features can be linked with the key words or phrases. For example, document entry file for a web page in a shopping site selling a music CD may includes the name of the CD as key word or phrase, and words or phrases describing the type of music, the release date, the song and music creator, the performer, the label, the content, etc., along with words or phrases identifying the types of features they are describing.

Usually, nouns are used as key words or phrases, and not only proper nouns and common nouns can be used as key words or phrases, abstract nouns can also be key words or phrases. For abstract noun phrases, different combinations of words may stand for the same meaning, the document entry files may include all the combinations. Words or phrases in the documents can be cross-linked with each other. For example,

The key words or phrases can be categorized or ranked. Key words or phrases that are narrower in meaning than other key words or phrases can be grouped with these other key words or phrases. In one preferred embodiment of the present invention, the ranking and/or categorization of the key words or phrases can be done by using identification value and link information of the word element files.

The document entry files may include information for the date and time the web pages (documents) are created, and other information such as type of documents. For example, a web page can be categorized as a news sites, an online shopping sites, a weblogs, etc.

In another preferred embodiment of the present invention, the document entry files comprise content words or word phrases (as file names) and containing lists of document names having the content words or word phrases, and corresponding address information of the documents having the content words or word phrases. Other information such as types of documents and summaries of the documents can also be included corresponding to document names respectively. In one preferred embodiment of the present invention, the lists of document names can be arranged according to types of the documents, such as the usages or purposes of the documents or web pages.

In this embodiment, document entry files will be established that each will include the addresses of all the documents that contain the corresponding word or phrase. Generally, only words of substances will have document entry files. For example, only words or phrases that fall into the categories of products, services, subjects, entities, people, activities, locations, etc. will have document entry files.

### Executing System

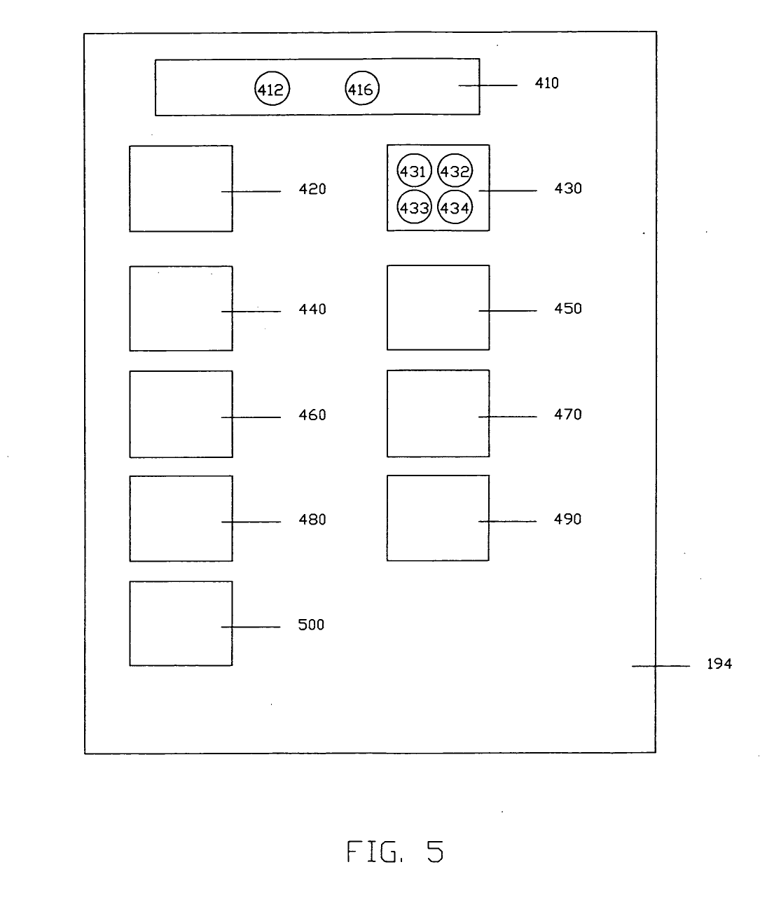

As seen in FIG. 5, the executing system 194 comprises an internal control mechanism 410, an inputting mode 420, a reading mode 430, at least one thinking mode 440, a writing mode 450 and a memorizing mode 460, an outputting mode 470, an inquiry mode 480, a verification mode 490, and a system update mode 500. The internal control mechanism 410 includes internal control rules 412 and structure rules 416. The inputting mode 420 includes inputting rules, wherein the reading mode 430 includes reading rules, wherein the thinking modes 440 include thinking rules, wherein the writing mode 450 includes writing rules, wherein the memorizing mode 460 includes memorizing rules, wherein the outputting mode 470 includes outputting rules, wherein the inquiry mode 480 includes inquiring rules, wherein the verification mode 490 includes verification rules, wherein the system update mode 500 includes system update rules. The internal control mechanism 410 can control the inputting mode 420, a reading mode 430, a thinking mode 440, a writing mode 450 and a memorizing mode 460, an outputting mode 470, an inquiry mode 480, a verification mode 490, and a system update mode 500, wherein the internal control mechanism 410 can operate constantly.

In one preferred embodiment of the present invention, a search process is provided. When users inputted terms in a designated input box for search in a designated web page, the internal control mechanism 410 of the executing system 194 activates the inputting mode 420 to receive the inputted terms. The inputting mode 420 makes initial processing of the inputted terms and passes the information to the reading mode 430, wherein the reading mode 430 reads the inputted terms and searches element files of the knowledge systems to find element files for words or phrases that are included in the inputted terms. The element files for words or phrases that are included in the inputted terms will be identified and information in the element files is passed to the thinking mode 440. The thinking mode 440 processes the information in the element files for words or phrases that are included in the inputted terms and proceeds according to the information.

If the inputted term match element files for one word or phrase, the internal control mechanism 410 of the executing system 194 can activate the inquiry mode 480 to conduct searches in the document structure to search document entry files according to the document organizing mechanism. If the document entry files are structured that there are names for document entry files that match the inputted term, and the lists of web sites or web pages in document entry files are pre-arranged according to the types of web pages or web sites, then the inquiry mode 480 may send the document entry file for the inputted term directly to outputting mode 470 to be displayed to the users. If the lists of web sites or web pages in document entry files are not pre-arranged, then the inquiry mode 480 will send lists of the web sites or web pages to the writing mode 450, and the writing mode 450 will arrange the lists of web sites or web pages according to types of web sites or web pages and writing rules, the results are sent to outputting mode 470 to be displayed to the user.

If the document entry files are structured that words or phrases are contents of the document entry files, and the names of the document entry files are names of the web sites or web pages, then there usually are multiple matches in the contents of document entry files for one inputted term. Names and addresses of all web sites or web pages corresponding to document entry files having contents matching with the inputted term will be obtained and sent to writing mode 450 along with information such as the types of corresponding web sites or web pages. The writing mode 450 arranges the lists of web sites or web pages according to the types of web sites or web pages and writing rules, the results are send to outputting mode 470 to be displayed to the user.

The second link information files 2122 of the element files for inputted terms include words or phrases having similar meanings as the inputted terms. The inquiry mode 480 can conduct searches in the document structures to search document entry files according to the document organizing mechanism to find matches of the words or phrases of document entry files and the words or phrases having similar meanings as the inputted terms, then the writing mode 450 and outputting mode 470 can write and display the results in the same ways as for the matches for the inputted terms. Links to the web pages or web displays for words or phrases in the second link information files 2122 of the element files for inputted terms can be provided in the web pages or web displays for the inputted terms.

The first link information files 2121 of the element files for inputted terms include words or phrases having broader and narrower meanings as the inputted terms. The inquiry mode 480 can conduct searches in the document structures to search document entry files according to the document organizing mechanism to find matches of the words or phrases of document entry files and the words or phrases having broader and narrower meanings as the inputted terms, then the writing mode 450 and outputting mode 470 can write and display the results in the same ways as for the matches for the inputted terms. Links to the web pages or web displays for words or phrases in the first link information files 2121 of the element files for inputted terms can be provided in the web pages or web displays for the inputted terms.

The sixth link information files 2126 of the element files for inputted terms include words or phrases describing features of the inputted terms along with words or phrases identifying the features. The inquiry mode 480 can conduct searches in the document structures to search document entry files according to the document organizing mechanism to find matches of the words or phrases of document entry files and the words or phrases describing features of the inputted terms respectively. Then, the writing mode 450 and outputting mode 470 can write and display the results in the same ways as for the matches for the inputted terms. Links to the web pages or web displays for words or phrases in the sixth link information files 2126 of the element files for inputted terms describing features of the inputted terms can be provided in the web pages or web displays for the inputted terms, along with the words or phrases identifying the features.

For the document entry files having document names (web site or web page names) as document entry files, and contents of document entry files having key words or phrases along with words or phrases describing features of the key words or phrases and words or phrases identifying the features, the inquiry mode 480 can also conduct searches in the document structures to search document entry files according to the document organizing mechanism to find matches of the pairs of words or phrases in document entry files and the pairs of words or phrases describing features of the inputted terms and identifying the features. The key words or phrases in the document entry files linked to the pairs of words or phrases describing features of the key words or phrases and identifying the features can be obtained. The lists of key words or phrases can be displayed according to the features, and links to the web pages or web displays for the lists of key words or phrases having the features can be provided in the web pages or web displays for the inputted terms, along with the words or phrases identifying the features. And, for each key word or phrase, inquiry mode 480 can conduct searches in the document structures to find matches of the words or phrases of document entry files and the key words or phrases sharing features of the inputted terms. Then the writing mode 450 and outputting mode 470 can write and display the results in the same ways as for the matches for the inputted terms. Links to the web pages or web displays for key words or phrases sharing features of the inputted terms can be provided in the web pages or web outputs for the inputted terms, identified by the shared features.

In one preferred embodiment of the present invention, if the user inputted more than one terms, the executing system 194 still assume that the users are trying to find one thing for each input. The inputted terms could be terms that identifying things (subject words or phrases) and terms that describing things (feature words or phrases). The inputted terms can also include words or phrases that identify the types of features (attributes) that other inputted terms are describing.

If the document entry files have document names (web site or web page names) as document entry files, and contents of document entry files including key words or phrases along with words or phrases describing features of the key words or phrases and words or phrases identifying the features, and the inputted terms are terms that identifying things and terms that describing things, the inquiry mode 480 can conduct searches in the document structures to find matches of the groups of words or phrases in document entry files and the groups of the inputted terms. Generally speaking, the inputted terms describing features of things are used to narrow down the searches, i.e., search results using all the inputted terms will be less than search results using only the single inputted terms that identify things. The writing mode 450 and outputting mode 470 can write and display the results in the same ways as for the matches for single inputted terms. If users inputs are in sentence format, the executing system first analyzes the sentence and finds terms that identifying things and terms that describing things.

If the document entry files have document names (web site or web page names) as document entry files, and contents of document entry files include key words or phrases along with words or phrases describing features of the key words or phrases and words or phrases identifying the features, and if the inputted terms are groups of words or phrases describing certain features of certain things and words or phrases identifying corresponding features, then the inquiry mode 480 can conduct searches in the document structures to find matches of the groups of words or phrases in document entry files and the groups of the inputted terms. The results would be key words or phrases having features described and identified by the inputted terms, more than one key words or phrases can be obtained. The lists of key words or phrases can be displayed with the shared features. And, for each key word or phrase, inquiry mode 480 can conduct searches in the document structure to find matches of the words or phrases of document entry files and the key words or phrases having features of the inputted terms. Names and addresses of all web sites or web pages having words or phrases matching with the key word or phrase will be obtained and sent to writing mode 450 along with information such as the types of corresponding web sites or web pages. The writing mode 450 arranges the lists of web sites or web pages according to the types of web sites or web pages and writing rules, the results are send to outputting mode 470 to be displayed to the users. The web pages or web displays for results of each key word or phrase searches can be linked with the displays of the lists of key words or phrases in the initial search result with shared features.

The thinking mode 440 can use the second link information files 2122 of any inputted terms to obtain more search results. The search results can be arranged according to the words or phrases used for the searches, and web pages for displaying the search results can be linked with the main pages of the search results for the inputted terms.

Essentially, words or phrases that have different meanings can be treated as if they are different words or phrases. Thus, for words or phrases have multiple meanings, multiple web pages or web displays can be provided, each corresponding to one particular meanings Words or phrases that have different meanings will have different features, thus features associated with words or phrases identifying things can be used to distinguish words or phrases with different meanings.

The writing mode 450 of the executing system arranges the search results according to the types of words or phrases of the inputted terms used for the searches. For example, if the sixth identification values 2116 of the element files for words or phrases indicate the type of words or phrases of the inputted terms is product, then the lists of websites or web pages from the search results can be arranged according to functions of the websites or web pages, such as shopping sites, and information sites, etc. The lists can be arranged in more details. For example, the shopping sites may include auction sites, classified sites, comparative shopping sites, store sites, etc., the information sites may include basic information, consumer information, business information, etc. The lists can be further arranged in more details. The purpose of this arrangement is to help the users to find the web sites or web pages that are most useful for them quickly. The writing mode 450 arranges the list of web sites or web pages according to the information from the document entry files regarding the types of web sites or web pages and the writing rules, wherein different writing rules correspond to different types of words or phrases, or the combinations thereof. The outputting mode 470 displays the arranged search results to the users' displaying devices according to information from the writing mode 450.

In one preferred embodiment of the present invention, web pages are processed to obtain types of web pages according to information related to the web pages or contents of the web pages, wherein the information related the web pages includes url addresses (links) of the web pages, icons (or texts) connected to the links for the web pages, metadata of the web pages, etc. The web pages and information related to the web pages can be directly feed to the executing system of the present invention. Or, the web pages and information related to the web pages can the results of web crawlers that can be processed by the executing system of the present invention.

In one preferred embodiment of the present invention, url addresses of web pages may contain information that can be processed to determine the types of web pages. For example, url addresses end with .gov (or .gov/home.html as home page) are assumed as government sites, or url addresses end with .edu (or .edu/home.html as home page) are assumed as educational sites, or url addresses end with .org (or .org/home.html as home page) are assumed as organization sites, etc. In other cases, a portion of the url addresses include certain words may indicate the types of the sites of the web pages. For example, url addresses include . . . /news/ . . . might indicate the types of the web pages are news sites, url addresses include . . . /auctions/ . . . might indicate the types of the web pages are auction sites, etc. Or, url addresses include . . . /dictionaries/ . . . may indicate the types of the web pages that be categorized as reference sites; url addresses include . . . /services/ . . . may indicate the types of the web pages are offer sites, etc.

In one preferred embodiment of the present invention, icons (or texts) connected to links for the web pages may contain information that can be processed to determine the types of web pages. The icons (or texts) connected to the links of web pages can appear in other web pages containing the links (in web pages of upper stream links of the web pages, they can be located in particular locations, or embedded in the content texts) or in the same web pages where upper (or lower) stream links can also be provided (they usually located in particular locations). Often, the information from icons (or texts) is combined with other information to determine the types of web pages. For example, if the web sites are shopping sites (determined by other means), then the icon connected to links of web pages that include information such as words such as “products” (or more specific products such as computers, books, etc.) may indicate the web pages are also for shopping sites (while other web pages of these web sites may be information sites). In some cases, information provided by the texts in icons connected to links of web pages alone can be used to presume that the web pages are of certain types. For example, if the text in the icon connected to link of web page is “news”, then the type of web pages is news site; if the text in the icon connected to link of web page is “store”, then the type of web pages is store site.

In one preferred embodiment of the present invention, metadata of web pages may contain information that can be processed to determine the types of web pages. For example, the metadata of the home page may contain information to indicate that the web site is a web site for a computer manufacturer; the metadata of certain web pages may contain information to indicate that the web pages are for a store, and the metadata of certain web pages may contain information to indicate that the web pages are for product information, etc.

In one preferred embodiment of the present invention, contents of web pages may contain information that can be processed to determine the types of web pages. Generally speaking, terms standing alone in the contents of the web pages are often indications of the types of information of the contents, especially certain key terms usually indicate certain types of contents, which can be used to identify the types of web pages. For example, if the contents of the web pages may contain articles identified by word “reviews”, then the web pages are web pages for reviews. The terms are often presented in particular positions of the web pages, or in particular format. For example, “reviews” can be presented in different color, different font, different indent setup than the text of the article. Contents can be used to decide the type of web page when there are multiple possibilities. For example, if the web site is known to be a site of a magazine, then it is possible that a particular web page is for reviews, for advices, or for general articles related to certain subjects. Then if “reviews” appeared in certain web pages in ordinarily identifying format, then the web pages can be identified as the types of web pages for product or service reviews.

Sometimes, the meanings of the contents can also be used to determine the types of web pages. For example, by using the thinking system, the subjects of the articles can be determined by using sentence analysis or summary process, and if the articles talked about various features of certain products, then the articles are either for product reviews or product information. Then either sentence analysis will reveal that the articles are for product reviews or product information, or other information such as appearing of term “reviews” or the possible types of web pages provided can be used to determine the types of web pages.

In one preferred embodiment of the present invention, types of web pages can be determined from processing information of other web pages. If a link to a web page is embedded to another web page, then the texts in this other web page may provide indications about the type of the web page with this link. For example, if the text in the web page with the embedded link is a directory or index of the web site, a portion of a directory or index of the web site, or something similar in function, then the type and content of directory or the layout of the directory would help to determine the type of web page with the link. The directory can be analyzed by processing the format of the layout, key terms, and using sentence analysis and summarizing process.

In one preferred embodiment of the present invention, types of web pages can be determined from types of other web pages in the same web sites. For example, if the type of most of other web pages in the same web site is for references, then if there is no other information, then a web page in the web site will be presumed to be a reference web page. In some cases, the web pages in a web site can be presumed to be one type, and if there is no other information, then a web page in the web site will be presumed to be this type.

In one preferred embodiment of the present invention, web pages of lower streams of the links are assumed to be of the same types as the web pages of upper streams of the links. However, certain identification components (icons) in the web pages of upper links or in the url address of the links can change the types of web pages in lower streams of the links. For example, the upper streams of the links could be links for web pages of stores, the lower streams of the links could be links for web pages for various items selling in the stores. Some cases, some lower streams of the links could be links for web pages for reviews of various products. However, the changes of web page types usually will be indicated in the icons of (or texts related to) the links, information in the url addresses of the links, or in the texts of the web pages. So, unless other information that can identify the types of the web pages are found, the types of web pages can presumed to be the same as the types of web pages of the upper streams of the links.

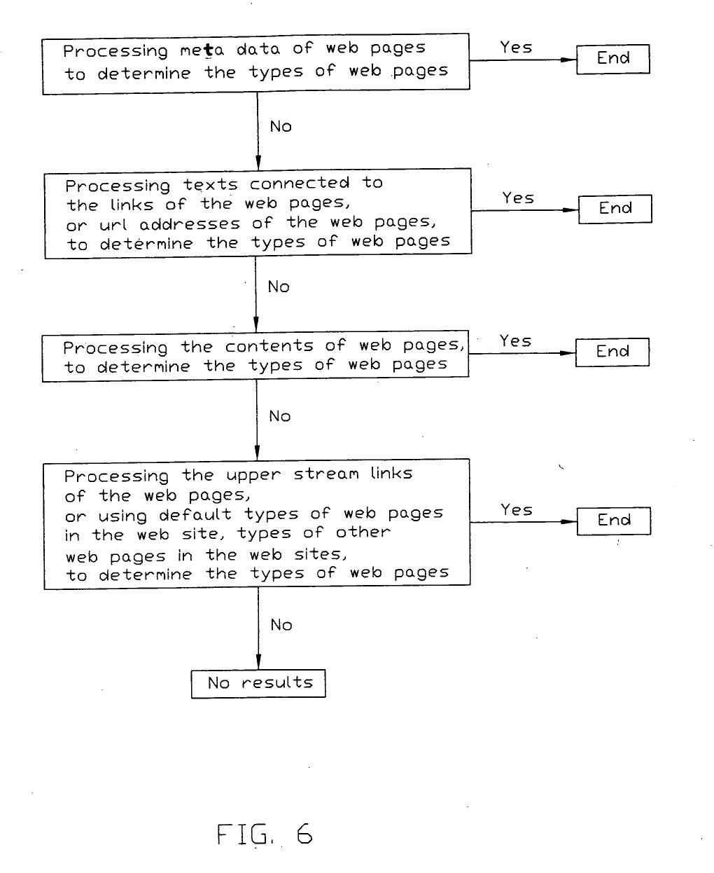

The types of web pages can be determined by processing all the relevant information. As seen in FIG. 6, in one preferred embodiment of the present invention, metadata of web pages will first be processed by the executing system of the present invention to determine the types of web pages. If the metadata have not indicated the types of web pages, then the icons (or texts) connected to the links of the web pages, or the url addresses of the web pages can be processed by the executing system to determine the types of web pages. If the types of web pages cannot be determined by processing the icons (or texts) connected to the links of the web pages, or the url addresses of the web page, then the contents of the web pages can be processed by the executing system to determine the types of web pages. The icons (or texts) connected to the links, or the url addresses of the web pages and the contents of the web pages can be processed in combination to determine the types of web pages. For example, if the url address of the web page includes . . . /downloads/ . . . , and the contents is about software, then the web page is offering software, so the type of web page can be determined as “offers”.

If the types of the web pages still cannot be determined, then the upper stream links of web pages can be processed to determine the types of web pages of the links in lower stream; or the default types of web pages in the web sites or types of other web pages in the web sites can be used to determine the types of particular web pages.

What is claimed is:

1. A method of displaying a web directory to web browsers, implemented by a system including one or more CPU's, one or more I/O devices, and one or more memories, comprising the steps of:
displaying descriptions indicating web pages including certain terms; and
displaying lists of web pages having said certain terms, wherein the web pages are arranged according to the types of web pages, with descriptions about the types of web pages, wherein the types of web pages are categorized according to general usages that can all be independent of the certain terms, wherein the web pages are generally displayed under more than one categories at the same display.

2. A method as claimed in claim 1, wherein the lists of web pages are displayed in groups that includes subgroups.

3. A method as claimed in claim 1, wherein links to other terms related to the certain terms are identified and provided in the displays of lists of web pages having said certain terms.

4. A method as claimed in claim 3, wherein the other terms include terms that have similar meanings to the certain terms.

5. A method as claimed in claim 3, wherein the other terms include terms that have broader meanings to the certain terms.

6. A method as claimed in claim 3, wherein the other terms include terms that represent features of the certain terms.

7. A method of providing and displaying web search results to web browsers, implemented by a system including one or more CPU's, one or more I/O devices, and one or more memories, comprising the steps of:
receiving inputted terms;
searching document structure;
displaying descriptions indicating web pages having inputted terms; and
displaying lists of web pages having the inputted terms, wherein the lists of web pages are arranged according to the types of web pages, with descriptions about the types of web pages, wherein the types of web pages are categorized according to general usages that can all be independent of the certain terms, wherein the web pages are generally displayed under more than one categories.

8. A method as claimed in claim 7, further comprising the steps of analyzing the inputted terms, and obtaining other terms related to the inputted terms.

9. A method as claimed in claim 8, further comprising the steps of displaying lists of web pages having said other terms, and identifying and providing links to the displays of lists of web pages having said other terms in the displays of lists of web pages having inputted terms.

10. A method as claimed in claim 9, wherein the other terms are terms similar in meanings to the inputted terms.

11. A method as claimed in claim 9, wherein the other terms are terms broader in meanings to the inputted terms.

12. A method as claimed in claim 9, wherein the other terms are terms describing features of the inputted terms.

13. A system of providing and displaying web search results to web browsers, including one or more CPU's, one or more I/O devices, and one or more memories, comprising a document structure, wherein the document structure comprises document entry files, document contents, and document addresses, and document organizing mechanism, wherein the document entry files comprise key terms, and information about types of web pages, wherein the types of web pages are categorized according to general usages that can all be independent of the key terms, wherein the web pages are generally displayed under more than one categories.

14. A system as claimed in claim 13, further comprising a knowledge structure, and an executing system, wherein the knowledge structure further comprises element files, and file organizing mechanism.

15. A system as claimed in claim 14, wherein the executing system further comprises an internal control mechanism, an inputting mode, a writing mode, an outputting mode, and an inquiry mode.

16. A system as claimed in claim 15, wherein the internal control mechanism directs the inputting mode to receive inputted terms, and inquiry mode to search the document structure for the inputted terms, and writing mode to write the displays of lists of web pages having inputted terms according to writing rules and types of web pages in document entry files, and outputting mode to display to the web browsers.

17. A system as claimed in claim 16, wherein the executing system further comprises a reading mode and thinking mode, wherein the internal control mechanism directs the reading mode to read inputted terms to obtain element files corresponding to inputted terms, and thinking mode to retrieve information from the element files corresponding to the inputted terms.

18. A system as claimed in claim 17, wherein the information retrieved from the element files corresponding to the inputted terms includes terms similar in meaning to the inputted terms, wherein the internal control mechanism directs the inquiry mode to search the document structure for the terms similar in meaning to the inputted terms, and writing mode to write the displays of lists of web pages having terms similar in meaning to the inputted terms, and write the links to the displays of lists of web pages having terms similar in meaning to the inputted terms in the display pages of lists of web pages having inputted terms according to writing rules and types of web pages in document entry files, and outputting mode to display to the web browsers.

19. A system as claimed in claim 17, wherein the information retrieved from the element files corresponding to the inputted terms includes terms broader in meaning to the inputted terms, wherein the internal control mechanism directs the inquiry mode to search the document structure for the terms broader in meaning to the inputted terms, and writing mode to write the displays of lists of web pages having terms broader in meaning to the inputted terms, and write the links to the displays of lists of web pages having terms broader in meaning to the inputted terms in the display pages of lists of web pages having inputted terms according to writing rules and types of web pages in document entry files, and outputting mode to display to the web browsers.

20. A system as claimed in claim 17, wherein the information retrieved from the element files corresponding to the inputted terms includes terms describing features of the inputted terms, wherein the internal control mechanism directs the inquiry mode to search the document structure for the terms describing features of the inputted terms, and writing mode to write the displays of lists of web pages having terms describing features of the inputted terms, and write the links to the displays of lists of web pages having terms describing features of the inputted terms in the display pages of lists of web pages having inputted terms according to writing rules and types of web pages in document entry files, and outputting mode to display to the web browsers.
